(19) United States
(12) Patent Application Publication
(10) Pub. No.: US 2009/0285522 A1
(43) Pub. Date: Nov. 19, 2009

(54) OPTICAL WAVEGUIDE, OPTICAL DEVICE, AND OPTICAL COMMUNICATION DEVICE

(75) Inventors: Akiko Gomiyou, Tokyo (JP); Jun Ushida, Tokyo (JP); Hirohito Yamada, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 11/813,417

(22) PCT Filed: Jan. 6, 2006
(86) PCT No.: PCT/JP06/00111

§ 371 Date: Oct. 3, 2007

(30) Foreign Application Priority Data
Jan. 6, 2005 (JP) 2005-001882

(51) Int. Cl. G02B 6/12; G02B 6/10

(52) U.S. Cl. 385/14; 385/129

(57) ABSTRACT

There is provided an optical device and an optical waveguide composed of a photonic crystal in which two optical waveguide modes that are orthogonal to a light propagation direction can be used, whereby design latitude is increased.

In the optical waveguide device composed of a photonic crystal, in a dispersion relationship of the photonic crystal, light is propagated using a refractive index guide mode that is a minimum frequency optical waveguide mode. Alternatively, two optical waveguide modes that are orthogonal to light propagation direction are used, a linear defect waveguide mode is used for the first optical waveguide mode; and light is propagated in the second light guide mode by using a refractive index guide mode that is a minimum frequency optical waveguide mode in a dispersion relationship of the photonic crystal. Alternatively, in a dispersion relationship of the photonic crystal, light is propagated in two optical waveguide modes that are orthogonal to a light propagation direction using a refractive index guide mode that is a minimum frequency optical waveguide mode.

### TECHNICAL FIELD

The present invention relates to an optical waveguide composed of a photonic crystal that is obtained by aligning, in a one-dimensional, two-dimensional, or three-dimensional period, two or more types of materials having different refractive indices; and to an optical device and an optical communication device that comprise the optical waveguide.

### BACKGROUND ART

A photonic crystal in which two or more types of materials having different refractive indices are arranged in a multi-dimensional period in an optical wavelength order (usually 0.3 to 0.7 μm) can be expected to have a strong light-confining effect created by a photonic band gap, and can be expected to be used in applications in various optical devices, very small optical circuits, and other devices in which the photonic crystal is used. A configuration is also known in which a linear defect is provided to the photonic crystal, whereby an optical waveguide is formed inside the photonic crystal (for example, see Non-patent Document 1).

Non-patent Document 1: J. D. Joannopolos, P. R., Villeneuve, and S. Fan Photonic Crystal: putting a new twist on light, Nature, paragraph 386, page 143, 1997.

Non-patent Document 2: Extended Abstracts from the 51st meeting of the Japan Society of Applied Physics and Related Societies, Kitagawa et al., vol. 3, page 1169, presentation number 31a-M-3

Non-patent Document 3: Physical Review Letters (2001), Iritomi et al., vol. 87, number 25, pages 253902 to 253905, FIG. 3.

### DISCLOSURE OF THE INVENTION

### Problems the Invention is Intended to Solve

An electromagnetic wave (light) in an optical waveguide that is composed of a photonic crystal has an optical waveguide mode enabling the wave to be guided (light to be propagated) and a slab mode or radiation mode in which guiding is disabled (light is not propagated).

An optical waveguide obtained by providing a linear defect to the photonic crystal (referred to below as a “linear defect optical waveguide”) generally has, as an optical waveguide mode, a linear defect waveguide mode formed in a photonic band gap situated between two slab mode bands that are obtained by providing the linear defect.

For this reason, conventional optical waveguides composed of a photonic crystal have been problematic in that, of the two optical waveguide modes that are orthogonal to a light propagation direction, only the polarized light having an electric field vector such that a photonic band gap will be formed can be propagated, and little latitude is afforded when designing the optical waveguide and optical devices using the optical waveguide.

For example, Non-patent Document 2 discloses a photonic crystal structure exhibiting polarization independence in a photonic band gap. However, in an optical waveguide composed of the photonic crystal, neither of the two optical waveguide modes that are orthogonal to the direction of propagation of light can be configured so that waves can be guided.

With the foregoing problems in view, it is an object of the present invention to provide an optical device and an optical waveguide composed of a photonic crystal in which two optical waveguide modes that are orthogonal to the direction of propagation of light can be used, and in which a greater degree of design flexibility is provided.

### Means for Solving the Aforementioned Problems

An optical waveguide according to a first aspect of the present invention is an optical waveguide comprising a photonic crystal obtained by aligning, in a one-dimensional, two-dimensional, or three-dimensional period, two or more types of materials having different refractive indices; the optical waveguide, characterized in that, in a dispersion relationship of the photonic crystal, light is propagated using a refractive index guide mode that is a minimum frequency optical waveguide mode. (See FIGS. 1 and 3)

An optical waveguide according to a second aspect of the present invention is an optical waveguide comprising a photonic crystal obtained by aligning, in a one-dimensional, two-dimensional, or three-dimensional period, two or more types of materials having different refractive indices; the optical waveguide, characterized in that two optical waveguide modes that are orthogonal to light propagation direction are used, a linear defect waveguide mode is used for the first optical waveguide mode, and light is propagated in the second light guide mode by using a refractive index guide mode that is a minimum frequency optical waveguide mode in a dispersion relationship of the photonic crystal. (See FIGS. 9 and 11)

An optical waveguide according to a third aspect of the present invention is an optical waveguide comprising a photonic crystal obtained by aligning, in a one-dimensional, two-dimensional, or three-dimensional period, two or more types of materials having different refractive indices; the optical waveguide, characterized in that, in a dispersion relationship of the photonic crystal, light is propagated in two optical waveguide modes that are orthogonal to a light propagation direction using a refractive index guide mode that is a minimum frequency optical waveguide mode. (See FIG. 10)

In the optical waveguide according to the present invention, the refractive index guide mode, which is a minimum frequency optical waveguide mode, is used to propagate light in a dispersion relationship of the photonic crystal, whereby light in two optical waveguide modes having electric field vectors in a direction that is substantially orthogonal to the light propagation direction can be propagated.

### Effect of the Invention

According to the present invention, two optical waveguide modes having electric field vectors in the direction that is substantially orthogonal to the light propagation direction can both be used in the optical waveguide composed of a photonic crystal. Therefore, the optical waveguide and a variety of optical devices in which the optical waveguide is used can be designed with greater latitude.

### BRIEF DESCRIPTION OF THE DRAWINGS

FIG. 1 is a perspective view showing an example of a configuration of a linear defect optical waveguide provided to a photonic crystal;

FIG. 2 is a perspective view showing an example of an electric field vector of light propagated in the linear defect optical waveguide shown in FIG. 1;

FIG. 3 is a graph showing a dispersion relationship of the optical waveguide mode shown in FIG. 2;

FIG. 4 is a graph showing light transmission characteristics of the optical waveguide mode shown in FIG. 2;

FIG. 5 is a perspective view showing a second example of an electric field vector of light propagated in the linear defect optical waveguide shown in FIG. 1;

FIG. 6 is a graph showing a dispersion relationship of the optical waveguide mode shown in FIG. 5;

FIG. 7 is a graph showing light transmission characteristics of the optical waveguide mode shown in FIG. 5;

FIG. 8 is a perspective view showing another example of a configuration of a photonic crystal in which a linear defect optical waveguide is formed;

FIG. 9 is a perspective view showing yet another example of a configuration of a photonic crystal in which a linear defect optical waveguide is formed;

FIG. 10 is a perspective view showing still yet another example of a configuration of a photonic crystal in which a linear defect optical waveguide is formed;

FIG. 11 is a perspective view showing still yet another further example of a configuration of a photonic crystal in which a linear defect optical waveguide is formed;

FIG. 12 is a graph showing light transmission characteristics when light in a TE-like mode is propagated by a linear defect waveguide mode in a linear defect waveguide formed in a photonic crystal;

FIG. 13 is a graph showing light transmission characteristics when light in a TM-like mode is propagated by a refractive index guide mode in a linear defect waveguide formed in a photonic crystal;

FIG. 14 is a graph showing light transmission characteristics including a waveband that corresponds to a mode gap when light in a TM-like mode is propagated by a refractive index guide mode in a linear defect waveguide formed in a photonic crystal;

FIG. 15 is a graph showing light transmission characteristics including a waveband that corresponds to a mode gap when light in a TM-like mode is propagated by a refractive index guide mode in a linear defect waveguide formed in a photonic crystal having a structure in which pores are filled with SiO₂;

FIG. 16 is graph showing a condition of variations in a frequency of a mode gap when a ratio (r/a) of a lattice constant and a pore radius is varied as a parameter in a linear defect waveguide formed in a triangular lattice porous-type photonic crystal;

FIG. 17 is graph showing a condition of variations in a gap width of a mode gap when a ratio (r/a) of a lattice constant and a pore radius is varied as a parameter in a linear defect waveguide formed in a triangular lattice porous-type photonic crystal;

FIG. 18 is a plan view showing an example of a configuration of an optical device comprising the optical waveguide of the present invention;

FIG. 19 is a perspective view showing an example of a configuration of an optical switch comprising the optical waveguide of the present invention;

FIG. 20 is a plan view showing an example of a configuration of an optical add/drop multiplexer device comprising the optical waveguide of the present invention; and

FIG. 21 is perspective view showing an example of a configuration of an optical communication device comprising the optical waveguide of the present invention.

1, 12, 22, 321, 322, 42 Photonic crystal

2 Linear defect optical waveguide

3, 5, 7, 10 Photonic crystal region

4, 6, 8, 11 Linear defect region

131, 132, 231-234, 331-334 Thin linear optical waveguide

141, 142 Interface part

241, 242 Spot size converter

25 Micro heater

341, 342 3 dB coupler

41 SOI substrate

43 Channel waveguide

44 Optical fiber

### BEST MODE FOR CARRYING OUT THE INVENTION

Preferred embodiments of the present invention shall be described next with reference to the accompanying drawings.

(Optical Waveguide)

First, an optical waveguide according to a first embodiment of the present invention shall be described. A refractive index guide mode used by the optical waveguide of the present embodiment shall be described first. The refractive index guide mode is an optical waveguide mode in which light is guided by a difference in refractive indices, with the difference being formed by providing a linear defect to a photonic crystal.

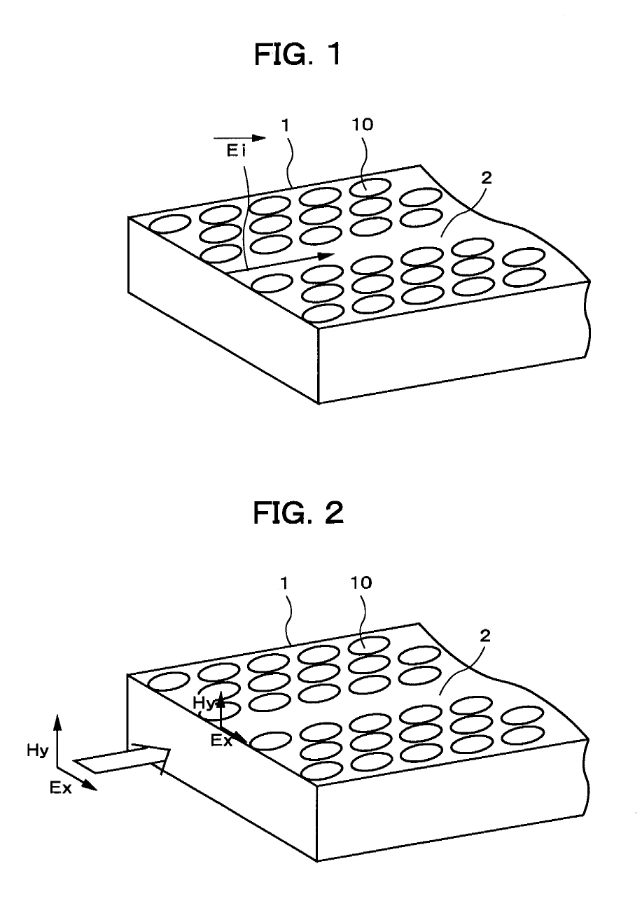

FIG. 1 is a perspective view showing an example of a configuration of a linear defect optical waveguide provided to a photonic crystal. FIG. 2 is a perspective view showing an example of an electric field vector of light propagated in the linear defect optical waveguide shown in FIG. 1.

The optical waveguide shown in FIG. 1 comprises as a photonic crystal 1 a silicon (Si) slab layer on which is provided a plurality of pores 10. A linear defect region in which the pores 10 are not formed is provided to part of the optical waveguide. A refractive index of the linear defect region is set to a value higher than an average refractive index of the photonic crystal. The linear defect region constitutes a linear defect optical waveguide 2. Light is propagated in the linear defect optical waveguide 2 in the direction of the arrow (Ei) of FIG. 1.

The electric field vector of light propagated in the linear defect optical waveguide 2 is oriented, e.g., in a direction parallel to a slab plane of the photonic crystal, which is a direction orthogonal to the light propagation direction (Ex vector of FIG. 2), as shown in FIG. 2. Hereafter, the optical waveguide mode shall be referred to as a “TE-like mode” when the electric field vector of light propagated in the photonic crystal 1 is oriented toward the Ex vector shown in FIG. 2.

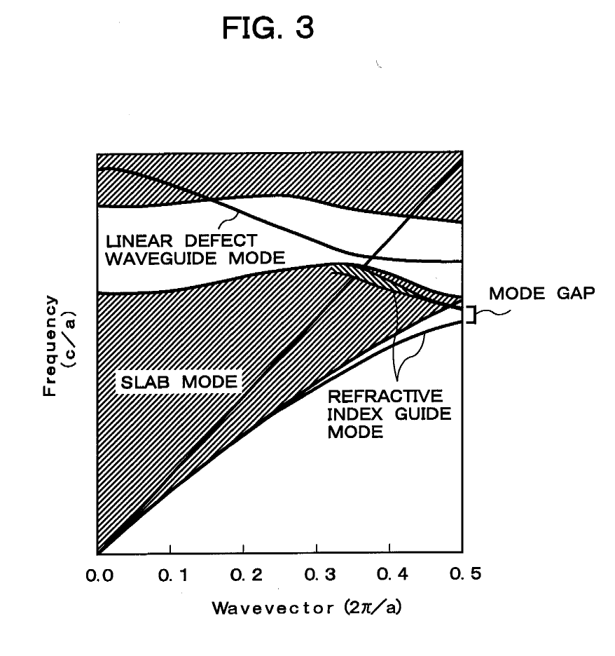

FIG. 3 is a graph of a dispersion relationship of the optical waveguide mode shown in FIG. 2. As shown in FIG. 3, when a normalized wave number k is near zero but is not equal to zero, light in the TE-like mode is propagated in the linear defect optical waveguide 2 shown in FIG. 1 by a refractive index guide mode that is present at a frequency less than a lower end frequency of a continuous slab mode band and that is a minimum frequency waveguide mode. Light in the TE-like mode is propagated by the refractive index guide mode in the linear defect optical waveguide 2 provided to the photonic crystal 1 for the following reasons.

The fact that the refractive index guide mode that is based on the structure of the linear defect optical waveguide is present at the minimum frequency of the slab mode band has already been made clear by, e.g., Non-patent Document 3. The refractive index guide mode is formed by a difference in the refractive index present in a direction orthogonal to the light propagation direction of the linear defect optical waveguide 2.

The frequency band of the refractive index guide mode that is based on the structure of the linear defect optical waveguide overlaps the slab mode band, as can be understood from the graph of FIG. 3. For this reason, the refractive index guide mode has conventionally exhibited a high level of propagation loss of light (TE-like mode), and it has been believed that the refractive index mode cannot be used as an optical waveguide mode.

However, the refractive index guide mode has a dispersion relationship near to the dispersion relationship of a simple thin linear optical waveguide that uses the material constituting the photonic crystal 1. For this reason, even if the frequency band of the refractive index guide mode is near the slab mode or is in the slab mode, a slight difference will occur in the refractive indices in the plane orthogonal to the direction of propagation of light, during which light will be propagated.

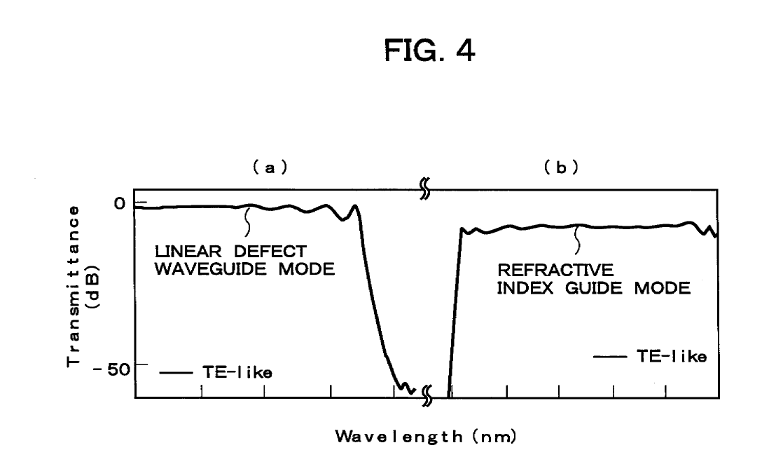

FIG. 4 is a graph showing results of a calculation of light transmission characteristics of the linear defect optical waveguide 2 shown in FIG. 1 using the FDTD (finite difference time domain) method.

A frequency band indicated by (a) of FIG. 4 in which the light transmission characteristics are level is the linear defect waveguide mode region. A frequency band indicated by (b) of FIG. 4 in which the light transmission characteristics are level is the refractive index guide mode region.

As shown by (b) of FIG. 4, the refractive index guide mode can propagate light with little propagation loss, as with the conventionally known linear defect waveguide mode ((a) of FIG. 4) that is formed in the photonic band gap. In other words, the refractive index guide mode can propagate light in a lower frequency band than the linear defect waveguide mode. In particular, in a region in which the normalized wave number k is near a Brillouin zone end, a large difference in relation to the wave number of the slab mode band will be exhibited. Therefore, the coupling between the two modes becomes weak, and light is only propagated by the refractive index guide mode.

The refractive index guide mode is preferably used as the optical waveguide mode in a range where the normalized wave number k is 0.25 or greater and 0.5 or less in the dispersion relationship of the photonic crystal for the following reasons.

As described above, light in the refractive index guide mode that is propagated in the linear defect optical waveguide 2 provided to the photonic crystal 1 is propagated while being affected by the slight difference in the refractive indices in the plane orthogonal to the light propagation direction even if the frequency band thereof is near the slab mode or is in the slab mode. The refractive index guide mode is often absent from the slab mode in a region in which the normalized wave number k of the refractive index guide mode is less than 0.25. In addition, the confinement effect on light that is based on the refractive index guide mode is weak in the region in which the normalized wave number k is less than 0.25. Therefore, propagation loss in the guided light will increase dramatically, and the strength of the propagated light will decrease from one one-hundredth to about one one-thousandth or less merely by traveling the distance of several μm. In contrast, when the normalized wave number k is 0.25 or greater, the confinement effect on light that is created by the refractive index guide mode will be more pronounced, and the refractive index guide mode will be distanced from the slab mode and present on the low-frequency side. For this reason, the effect derived from the refractive index guide mode will be pronounced, and light can be propagated with less loss. In this instance, the inventors of the present application used simulations and the like to confirm that substantially no propagation loss occurred in the propagated light after traveling a distance of several hundreds of μm or more in the waveguide. Considering values ranging from 0 to 0.5, which is a first Brillouin zone, for the value of the normalized wave number k is equivalent to considering all wave numbers. Therefore, the normalized wave number k of the refractive index guide mode is preferably 0.25 or greater and 0.5 or less.

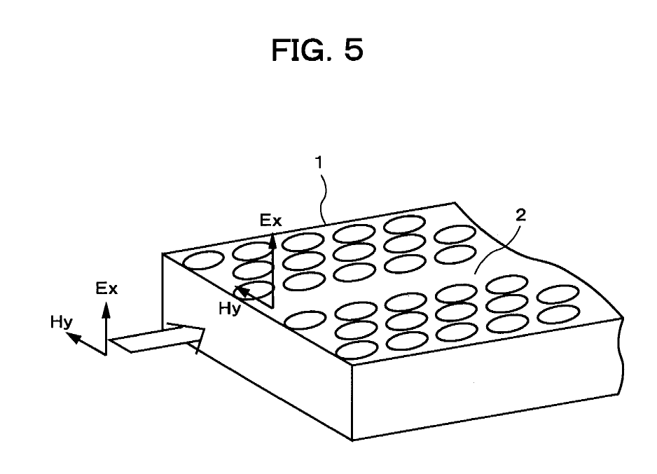

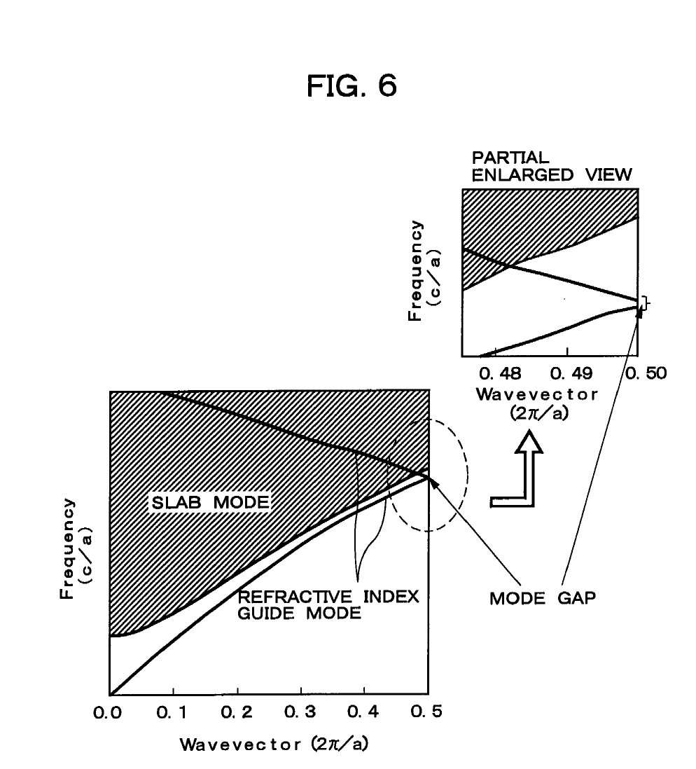

Another optical waveguide mode in which [light] is propagated in the linear defect optical waveguide shown in FIG. 1 shall be described hereunder. The electric field vector of light propagated in a linear defect optical waveguide provided to a photonic crystal is oriented not only in the TE-like mode shown in FIG. 2, but is also oriented orthogonal to a slab plane of the photonic crystal shown in FIG. 5 and orthogonal to the light propagation direction (the Ex vector of FIG. 5). In the linear defect optical waveguide provided to the photonic crystal 1, light can be propagated by a refractive index guide mode that is distanced further on the low-frequency side than the lower end frequency of the continuous slab mode band and that is formed on the basis of the structure of the linear defect optical waveguide, as shown in FIG. 6. Hereafter, an optical waveguide mode of light propagated in the linear defect optical waveguide 2 shall be referred to as a “TM-like mode” when the electric field vector of the light is oriented in the Ex vector shown in FIG. 5. Light in the TM-like mode can be propagated by the refractive index guide mode for the same reason that light in the above-described TE-like mode can be propagated.

The frequency band of light in the TM-like mode propagated by the refractive index guide mode overlaps the slab mode band in the same manner as with light in the TE-like mode, as shown in FIG. 6. For this reason, it has conventionally been thought that since light in the TM-like mode exhibits high levels of propagation loss in the refractive index guide mode, [the TM-like] mode cannot be used as an optical waveguide mode.

However, as indicated by the results of calculations of light transmission characteristics that are shown in FIG. 7 and are obtained by the FDTD method, the propagation loss of the TM-like mode is also low, and [the TM-like mode] can be used as an optical waveguide mode.

As described above, in the linear defect waveguide mode well-known in the prior art, of the two optical waveguide modes that are orthogonal to a light propagation direction, only the polarized light having an electric field vector such that a photonic band gap will be formed (the TE-like mode) can be propagated, and light in the TM-like mode cannot be propagated. According to the optical waveguide in which is used the refractive index guide mode, which is a characteristic of the present invention, light in the TM-like mode can also be propagated as well as light in the TE-like mode. Therefore, the optical waveguide and optical devices that use the optical waveguide can be designed with greater latitude.

As with the above-described TE-like mode, when light in the TM-like mode is propagated, the refractive index guide mode is preferably used as an optical waveguide mode in a range where the normalized wave number k is 0.25 or greater and 0.5 or less.

A specific example of an optical waveguide in which both light in the TE-like mode and light in the TM-like mode are propagated shall be described next.

As described above, in the linear defect optical waveguide 2 provided to the photonic crystal, the linear defect waveguide mode that is well-known in the prior art is used, whereby light in the TE-like mode can be propagated. In the optical waveguide of the present invention, the refractive index guide mode is used, whereby both light in the TE-like mode and light in the TM-like mode can be propagated.

In such instances, a band structure of the photonic crystal 1 is optimally set using as parameters the structure of the photonic crystal 1; a lattice constant of the photonic crystal 1 and the difference in the refractive indices, periodicity (ratio of the material having the higher refractive index to the material having the lower refractive index, periodic structure), and slab layer thicknesses of the two types of materials that constitute the photonic crystal 1. Accordingly, light in the TE-like mode and TM-like mode can both be propagated in the linear defect optical waveguide 2 while the same level of optical intensity is maintained. Light in the TE-like mode and light in the TM-like mode can both be propagated in the same frequency band.

Specifically, [the optical waveguide] is formed using an Si/SiO₂/Si substrate (SOI substrate) in which the thickness of the uppermost Si layer is about 0.25 μm and the thickness of the SiO₂ layer is about 1 μm. A plurality of pores is formed in the substrate in the form of a triangular lattice, whereby a triangular lattice porous-type photonic crystal is formed. A lattice constant [of the photonic crystal] is about 0.4 μm, and a pore diameter r is such that r/a is about 0.3. There is further provided in the light propagation direction a linear defect in which no pores are formed, whereby the linear defect optical waveguide 2 is formed. The length of the linear defect optical waveguide 2 is set between about 20 μm and 600 μm. When such a structure is adopted, both light in the TE-like mode and light in the TM-like mode can be propagated in the optical waveguide composed of the photonic crystal 1, which has been problematic in the prior art.

In the above description, an example was given in which light in the TE-like mode and light in the TM-like mode were propagated in the same frequency band in the linear defect optical waveguide 2 provided to the photonic crystal 1. However, light in the TE-like mode and light in the TM-like mode can be propagated in mutually different frequency bands as well.

Examples of other configurations of the photonic crystal on which the linear defect optical waveguide of the present embodiment is formed shall be described next.

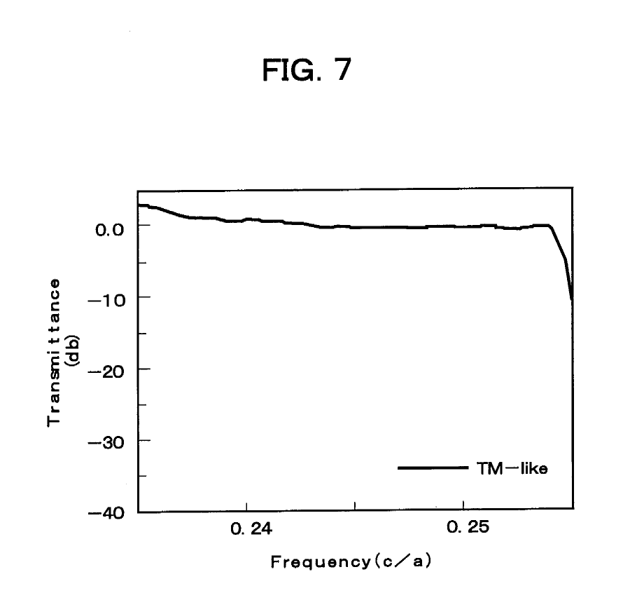

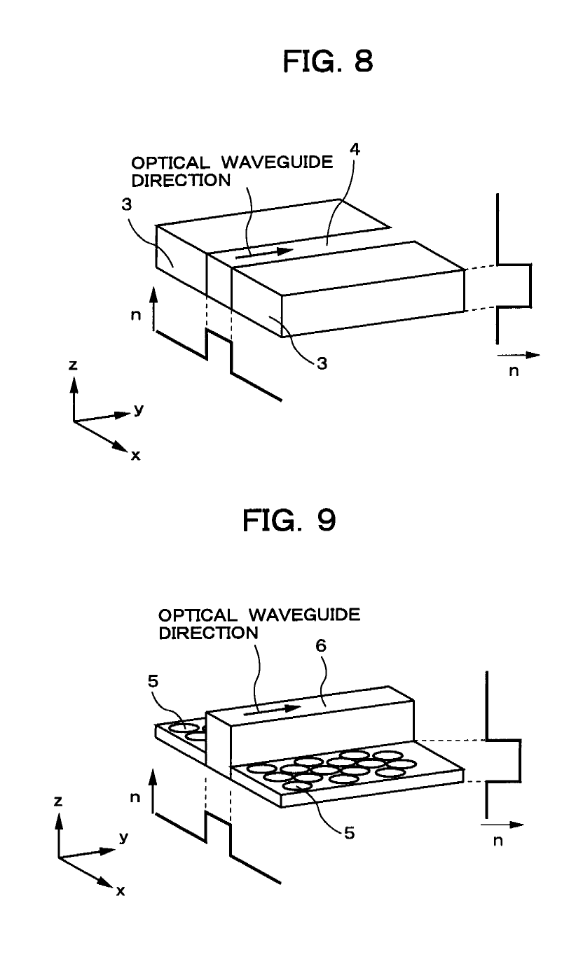

An optical waveguide shown in FIG. 8 illustrates a configuration for an optical waveguide composed of a typical photonic crystal that includes the optical waveguide shown in FIG. 1, and has a configuration in which photonic crystal regions 3 are formed on either side of a linear defect region 4. In such a configuration, light is propagated in a +y direction. The optical waveguide shown in FIG. 8 also has a configuration in which the refractive index distribution in an x direction is increased in the linear defect region 4. A consideration of the slab structure of the photonic crystal regions 3 and the refractive index distribution in the vertical direction (z-axis direction) of the slab structure reveals that the structure has a higher refractive index in the slab plane of the photonic crystal regions 3.

As shown in FIG. 8, a structure is provided in which an average refractive index of the linear defect region 4 is increased both in the x-axis direction and the z-axis direction, whereby light having an electric field vector substantially parallel to the x direction (TE-like mode) and light having an electric field vector substantially parallel to the z direction (TM-like mode) can both be propagated by the refractive index guide mode.

An optical waveguide shown in FIG. 9 has a configuration in which a width and height of a linear defect region 6 are suitably selected, and a slab layer of a photonic crystal region 5 is formed thinner than the linear defect region 6. As with the optical waveguide shown in FIG. 8, light having an electric field vector substantially parallel to the x-direction and light having an electric field vector substantially parallel to the z-direction can both be propagated by the refractive index guide mode in such a configuration. More specifically, when the linear defect optical waveguide is formed using the triangular lattice porous-type photonic crystal, [the optical waveguide] is formed so that, e.g., the lattice constant is 0.38 μm, the pore diameter is 0.16 μm, the width of the linear defect region is about 0.25 μm, and the thickness of the slab layer of the photonic crystal region is about 0.05 μm.

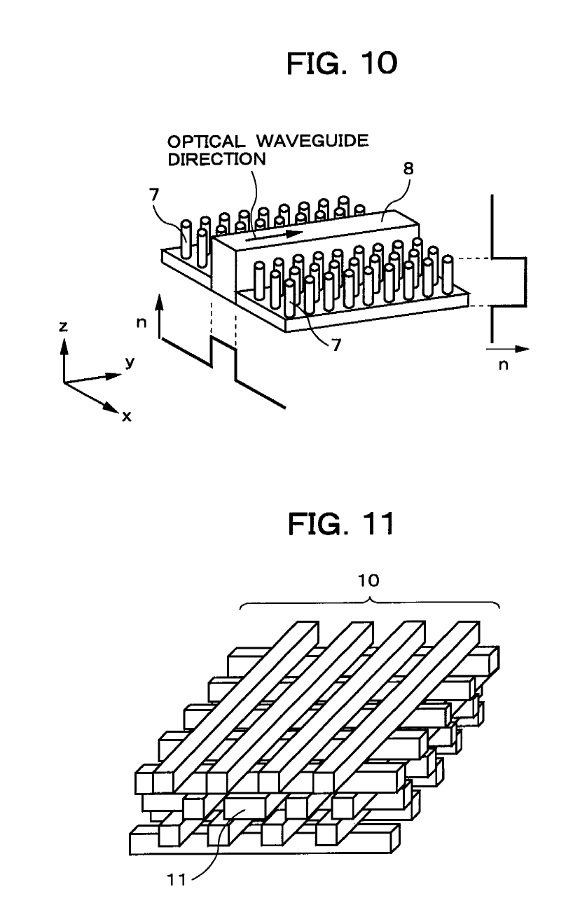

An optical waveguide shown in FIG. 10 has a configuration in which a square lattice rod-type [photonic crystal] comprising a plurality of square lattice rods is used in a photonic crystal region 7 formed on either side of a linear defect region 8. As with the optical waveguide shown in FIG. 8, light having an electric field vector substantially parallel to the x direction and light having an electric field vector substantially parallel to the z direction can both be propagated by the refractive index guide mode in such a configuration.

An optical waveguide shown in FIG. 11 has a configuration in which a three-dimensional photonic crystal structure is used. In this structure, a plurality of rod-shaped materials is layered on a photonic crystal region 10 with predetermined voids present therebetween. A linear defect region 11 is formed at a position surrounded by the photonic crystal region 10 by providing a material having a higher refractive index than the photonic crystal region 10. As with the optical waveguide shown in FIG. 8, two waves of light having electric field vectors substantially orthogonal to the light propagation direction can both be propagated by the refractive index guide mode in such a configuration.

Results obtained from validating the optical waveguides illustrated by the first embodiment shall next be described.

Results of measurements of the light transmission characteristics of the optical waveguide shall be indicated below using a sample in which the linear defect optical waveguide is formed in a triangular lattice porous-type photonic crystal. In the sample used for the measurements, Si is used as the slab layer of the photonic crystal. The sample has a so-called air bridge structure having a plurality of pores on both sides of the linear defect. The same effect as defined below can be obtained in a configuration in which the pores are filled with an SiO₂ insulating layer film.

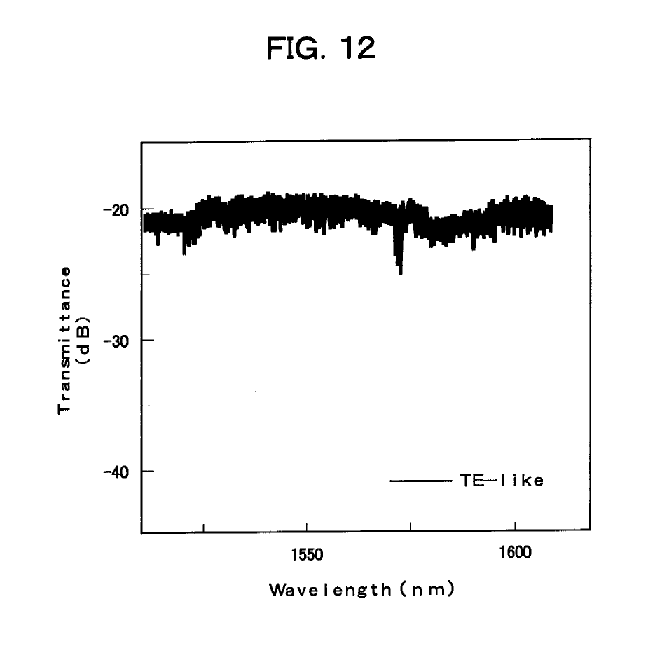

First, light in the TE-like mode that has a wavelength band near 1550 nm and that has an electric field vector parallel to the slab plane of the photonic crystal is propagated in the sample by the linear defect waveguide mode. The light transmission characteristics of the linear defect optical waveguide at this time are as shown in FIG. 12. In FIG. 12, the light transmission level is about −20 dB overall. However, this is due to the fact that the coupling loss of the linear defect optical waveguide and an optical fiber for emitting light onto the linear defect optical waveguide is about −10 dB, and the coupling loss of the linear defect optical waveguide and an optical fiber for receiving emitted light from the linear defect optical waveguide is about −10 dB. Therefore, the actual linear defect optical waveguide that is formed in the photonic crystal exhibits nearly no propagation loss.

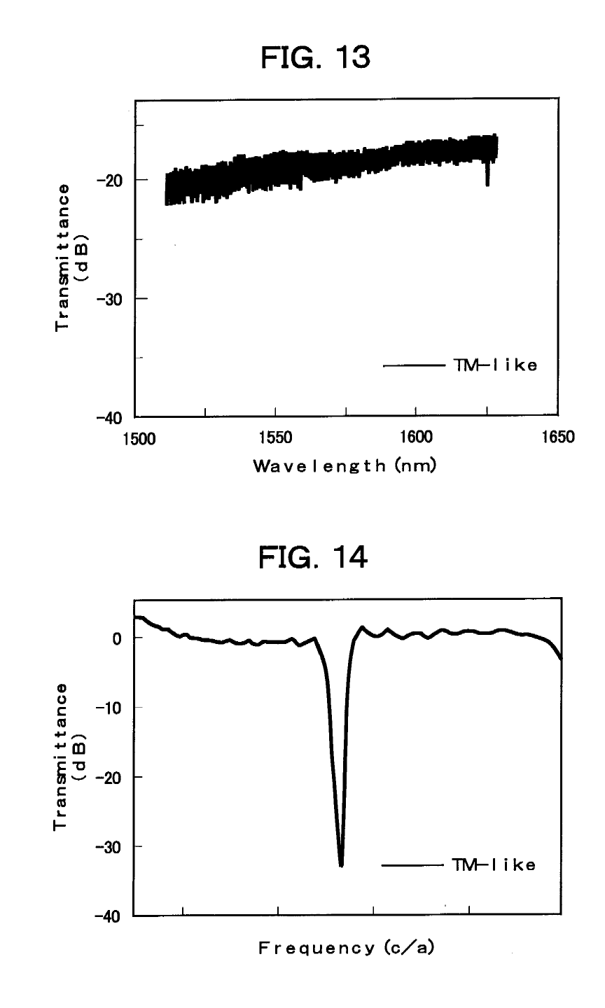

Next, the orientation of the electric field vector of the incident light is rotated 90 degrees, and light in the TM-like mode that is orthogonal to the slab plane of the photonic crystal impinges on the sample. The light transmission characteristics of the linear defect optical waveguide at this time are shown in FIG. 13.

As shown in FIG. 13, even when the orientation of the electric field vector of the incident light is rotated 90 degrees and light in the TM-like mode is propagated by the refractive index guide mode, the transmission characteristics of light having a wavelength band near 1550 nm were about the same as those shown in FIG. 12. Thus, the linear defect optical waveguide formed by providing the linear defect to the photonic crystal has the same transmission characteristics for both of the two waves of light having electric field vectors in the direction substantially orthogonal to the light propagation direction.

A mode gap of the refractive index guide modes of the linear defect optical waveguide shown in FIG. 1 shall be described next.

Light of the refractive index guide mode is returned (reflected) in a Brillouin zone end of a wave number space of the refractive index guide modes shown in FIGS. 3 and 6. In other words, in the Brillouin zone end, a mode gap is formed because of the presence of a periodic structure created by the refractive index in the light propagation direction. A mode gap when the optical waveguide mode is the TE-like mode is shown in FIG. 3. A mode gap when the optical waveguide mode is the TM-like mode is shown in FIG. 6.

When light is propagated by the refractive index guide mode in the linear defect optical waveguide formed in the photonic crystal, light is propagated with low loss in a range in which the normalized wave number k is 0.25 or greater and 0.5 or less in the dispersion relationship of the photonic crystal, as described above. On the other hand, light is not propagated in the linear defect optical waveguide in a frequency band of the mode gap.

FIG. 14 shows results of calculations of light characteristics, as compiled using the FDTD method, when light having an electric field vector orthogonal to the slab plane impinges on the linear defect optical waveguide.

A region in which the transmissivity of light dramatically decreases is present in a wavelength band that corresponds to the mode gap of the TM-like mode, as shown in FIG. 14.

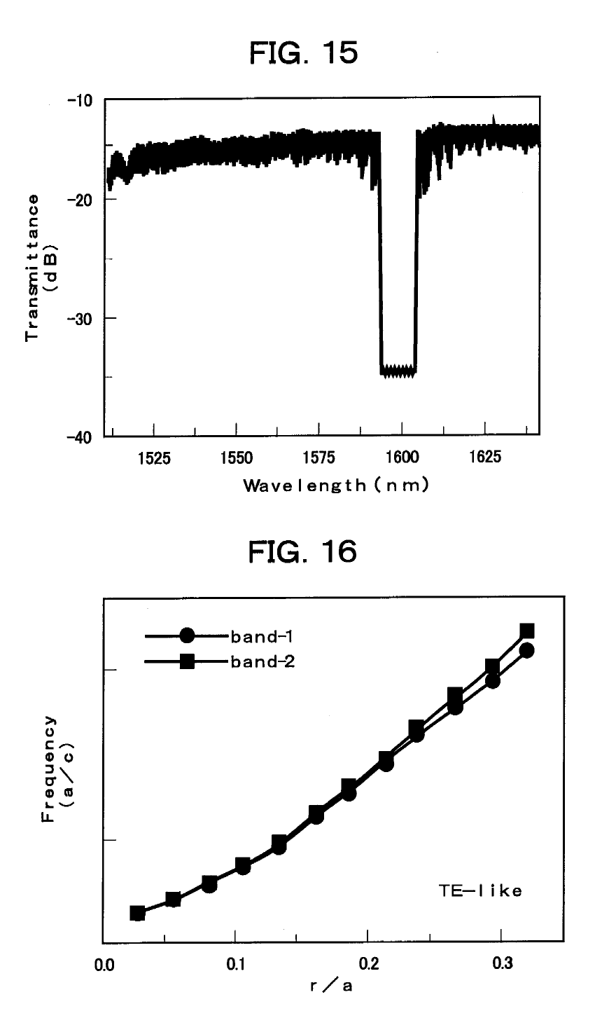

Results of the measurements of the light transmission characteristics taken using a sample having a structure in which the pores of the photonic crystal are filled with SiO₂ are shown in FIG. 15.

As shown in FIG. 15, the presence of the mode gap in which light transmissivity suddenly decreases for a wavelength width of about 10 nm in the vicinity of a wavelength of about 1600 nm was actually observed.

In order to control the frequency and gap width of the mode gap, the difference in the refractive indices of the materials constituting the photonic crystal, and the lattice constant and periodicity of the photonic crystal must be controlled.

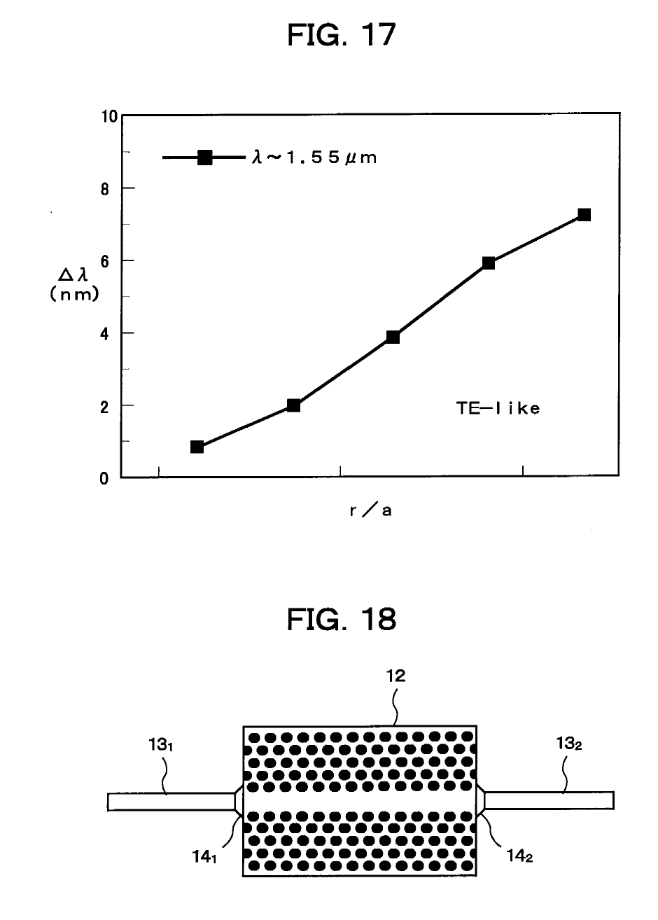

FIG. 16 shows a condition of variations in the frequency of the mode gap when a ratio (r/a) of a lattice constant (a) and a pore radius (r) is varied as a parameter in the triangular lattice porous-type photonic crystal, as an example in which the frequency and gap width of the mode gap are controlled. FIG. 17 shows a condition of variations in a gap width (Δλ) when (r/a) is varied as a parameter. FIGS. 16 and 17 show the results obtained from the calculations performed using the FDTD method. A band −1 of FIG. 16 is a lower frequency (low frequency side) of the mode gap (see FIG. 3) of the normalized wave number k of 0.5. A band −2 of FIG. 16 is an upper frequency (high frequency side) of the mode gap of the normalized wave number k of 0.5. FIG. 17 shows variation in the gap width (Δλ) in relation to variation in the ratio (r/a) of the lattice constant (a) and the pore radius (r) when light of the 1550 nm band is propagated.

As can be understood from FIGS. 16 and 17, varying the ratio (r/a) of the lattice constant (a) and the pore radius (r) enables the frequency and gap width of the mode gap to be controlled. It is also evident that a wavelength width of 1 nm or greater and 10 nm or less, which is effective in actual use, is obtained as the gap width.

FIG. 18 shows a configuration in which a well-known channel optical waveguide is provided to a light input/output part for the linear defect optical waveguide in order to reduce insertion loss of light toward the linear defect optical waveguide that is composed of a photonic crystal shown in FIG. 1.

The optical waveguide shown in FIG. 18 uses an SOI wafer having a Si/SiO₂/Si structure on a substrate (the thickness of the Si layers is about 0.25 μm, and the thickness of the SiO₂ layer is about 1 μm), and comprises a photonic crystal structure on the Si layer.

A linear defect optical waveguide is formed in a photonic crystal 12 by providing pores in the light propagation direction with a lattice constant a of about 0.4 μm and a pore radius r such that r/a is about 0.3 using a triangular lattice porous-type [photonic crystal] in which a plurality of pores is arranged into a triangular lattice shape.

Thin linear optical waveguides 131, 132 composed of Si are connected to a light input/output side of the linear defect optical waveguide. Trapezoidal interface parts 141, 142 about 0.3 μm in length are provided between the thin linear optical waveguides 131, 132 and the linear defect optical waveguide in order to decrease optical coupling loss.

The pores provided to the substrate are formed by, e.g., forming a resist having an opening at a pore formation region by electron beam exposure, and removing the Si layer by dry etching with the resist acting as a mask. The pores are then filled with SiO₂ to a thickness of about 1 μm.

In such a configuration, a ball-tipped single mode optical fiber is connected to an end surface of the thin linear optical waveguides 131, 132. When light in the TE-like mode and TM-like mode having a wavelength in the 1550 nm band is propagated by the refractive index guide mode, the same results as shown in FIGS. 12 through 15 are obtained for the light transmission characteristics.

Thus, when using the optical waveguide that employs the refractive index guide mode, which is a characteristic of the present invention, the same transmission characteristics are obtained for light in the TE-like mode and light in the TM-like mode. Therefore, an optical device comprising the optical waveguide can be designed with greater latitude.

GaAs, InP, a compound thereof (e.g., GaInAsP), an Al compound, and other materials having a refractive index of about 3 or higher can be selected instead of Si as the materials of the photonic crystal 12. In such instances, the lattice constant and pore diameter should be adjusted in order to set the light transmission wavelength to the 1550 nm band.

(Optical Switch)

A second embodiment in which the optical waveguide that employs the refractive index guide mode of the first embodiment of the present invention is used in an optical switch shall be described next.

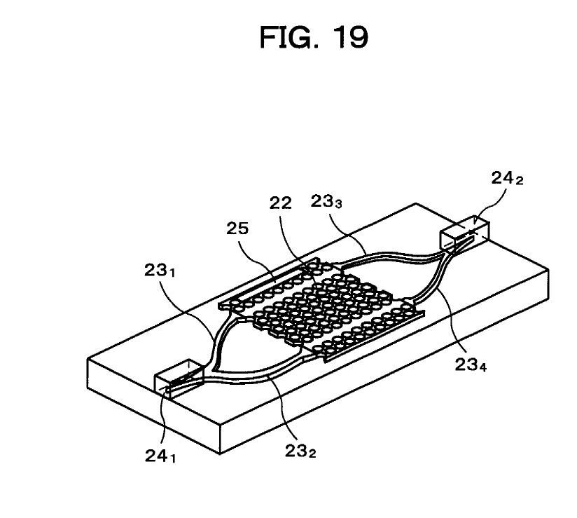

The optical switch comprises two linear defect optical waveguides provided to a photonic crystal 22, and thin linear optical waveguides 231 through 234 that are connected to input/output sides of the two linear defect optical waveguides, as shown in FIG. 19. Spot size converters 241, 242 for converting a light spot size are connected to distal ends of the thin linear optical waveguides 231 through 234 that are themselves connected to the input/output sides of the linear defect optical waveguides.

The thin linear optical waveguides 231, 232 that are connected to the input sides of the linear defect optical waveguides branch at input ends in the vicinity of the spot size converter 241. The thin linear optical waveguides 233, 234 that are connected to the output sides of the linear defect optical waveguides merge directly in front of the spot size converter 242. A micro heater 25 is provided in the vicinity of one of the linear defect optical waveguides.

In such a configuration, light directed through the spot size converter 241 is caused to branch in two directions by the thin linear optical waveguides 231, 232, and enters the linear defect optical waveguides composed of photonic crystals.

Light output from the two linear defect optical waveguides is caused to merge by the thin linear optical waveguides 233, 234, and output through the spot size converter 242. At this time, one of the linear defect optical waveguides is heated by the micro heater 25, whereby the temperature of the photonic crystal is changed, and the effective refractive index of the linear defect optical waveguide is changed. A phase difference of light output from the two linear defect optical waveguides can be changed from 0 to π by varying the refractive index. When the phase difference of the two waves of light is 0, the output light of the linear defect optical waveguides has the same intensity as the input light. When the phase difference is π, the output light of the linear defect optical waveguides has a light intensity of 0.

Thus, the two linear defect optical waveguides are formed in the photonic crystal, whereby the optical switch can be produced. In the present example, it shall be apparent that the above-described refractive index guide mode is used as the optical waveguide mode in the linear defect optical waveguides.

According to the present embodiment, the use of the optical waveguide that employs the refractive index guide mode, which is a characteristic of the present invention, makes it possible to switch light in the TE-like mode and light in the TM-like mode. Therefore, the optical switch can be designed with greater latitude.

(Optical Add/Drop Multiplexer Device)

A third embodiment in which the optical waveguide that employs the refractive index guide mode of the first embodiment of the present invention is used in an optical add/drop multiplexer device shall be described next.

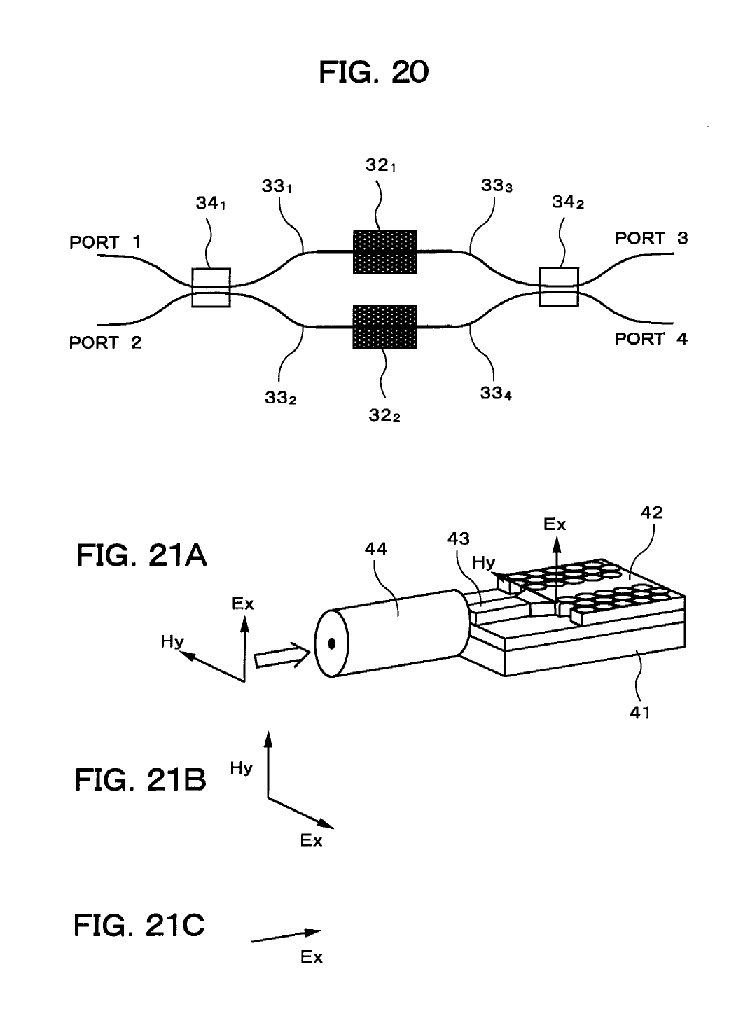

The optical add/drop multiplexer device comprises two photonic crystals 321, 322, which are disposed in parallel and on which are formed linear defect optical waveguides, and thin linear optical waveguides 331 through 334 that are connected to input/output sides of the linear defect optical waveguides, as shown in FIG. 20. The thin linear optical waveguides 331 through 334 that are connected to the input/output sides of the linear defect optical waveguides are disposed with portions situated near the input sides and output sides, whereby directional couplers are formed.

A gap at a core of the thin linear optical waveguides 331 through 334 is about 0.2 μm, and a length of a coupling region is about 2.5 μm. In this instance, a complete coupling length is about 5 μm, and 3 dB couplers 341, 342 are formed as the directional couplers. Light input from a port 1 of the thin linear optical waveguide 331 is caused to branch in two directions by the 3 dB coupler 341. At this time, the branched light is reflected by the linear defect optical waveguides at a wavelength that corresponds to the band gap space of the refractive index guide mode formed by the linear defect optical waveguides, and passes through the 3 dB coupler 341, whereby merged light is output from a port 2 of the thin linear optical waveguide 332 as drop light.

Light of other wavelengths is passed through the 3 dB coupler 342 of the output side and thereby caused to merge, and is output from a port 4 of the thin linear optical waveguide 334. Light having the same wavelength as that output from the port 2 is input from a port 3 of the thin linear optical waveguide 333, whereby merged light can also be output from the port 4.

According to the present embodiment, the use of the optical waveguide that employs the refractive index guide mode, which is a characteristic of the present invention, makes it possible to merge and separate light in the TE-like mode and light in the TM-like mode. Therefore, the optical add/drop multiplexer device can be designed with greater latitude.

(Optical Communication Device)

A fourth embodiment in which the optical waveguide that employs the refractive index guide mode of the first embodiment of the present invention is used in an optical communication device shall be described next.

As shown in FIG. 21, the optical communication device according to the present embodiment has a configuration in which a photonic crystal 42 and a channel waveguide 43 are formed on an SOI substrate 41, and an optical fiber 44 is connected via the channel waveguide 43 to a linear defect optical waveguide formed in the photonic crystal 42.

In general, light is propagated in the optical fiber 44 while the orientation of an electric field vector [of the light] rotates. For this reason, the orientation of the electric field vector of light entering the linear defect optical waveguide is uncertain. In other words, the orientation of the electric field vector of light entering the linear defect optical waveguide may be any of the directions (Ex) indicated by (1), (2), and (3) in FIG. 21.

Using the optical waveguide that employs the refractive index guide mode of the embodiment of the present invention allows light to be propagated by the linear defect optical waveguide without any incidence of propagation loss, regardless of the direction of the electric field vector of incident light. In FIG. 21, a configuration is shown only for a light input side of the linear defect optical waveguide formed in the photonic crystal 42. However, the orientation of the electric field vector of light supplied to the optical fiber can also be freely set in a configuration in which the optical fiber is connected to the output side of the linear defect optical waveguide.

### INDUSTRIAL APPLICABILITY

The optical waveguide composed of a photonic crystal of the present invention can thus be suitably used in various optical devices that comprise an optical waveguide.

1. An optical waveguide comprising a photonic crystal obtained by aligning, in a one-dimensional, two-dimensional, or three-dimensional period, two or more types of materials having different refractive indices; the optical waveguide, characterized in that
in a dispersion relationship of said photonic crystal, light is propagated using a refractive index guide mode that is a minimum frequency optical waveguide mode.

2. An optical waveguide comprising a photonic crystal obtained by aligning, in a one-dimensional, two-dimensional, or three-dimensional period, two or more types of materials having different refractive indices; the optical waveguide characterized in that
two optical waveguide modes that are orthogonal to light propagation direction are used,
a linear defect waveguide mode is used for the first optical waveguide mode; and
light is propagated in the second light guide mode by using a refractive index guide mode that is a minimum frequency optical waveguide mode in a dispersion relationship of said photonic crystal.

3. An optical waveguide comprising a photonic crystal obtained by aligning, in a one-dimensional, two-dimensional, or three-dimensional period, two or more types of materials having different refractive indices; the optical waveguide, characterized in that
in a dispersion relationship of said photonic crystal,
light is propagated in two optical waveguide modes that are orthogonal to a light propagation direction using a refractive index guide mode that is a minimum frequency optical waveguide mode.

4. The optical waveguide according to claim 1, characterized in that in said refractive index guide mode,
a normalized wave number k in the dispersion relationship of said photonic crystal is in a range of 0.25 or greater and 0.5 or less.

5. The optical waveguide according to claim 1, wherein the direction of propagation of light is periodic.

6. An optical device comprising the optical waveguide having a photonic crystal according to claim 1.

7. An optical communication device comprising the optical waveguide having a photonic crystal according to claim 1.
